(19) United States
(12) Patent Application Publication
(10) Pub. No.: US 2026/0219544 A1
(43) Pub. Date: Jul. 30, 2026

(54) ABSORBER OR SCATTER ASSISTED VARIABLE OPTICAL ATTENUATOR

(71) Applicant: Cisco Technology, Inc., San Jose, CA (US)

(72) Inventors: Rajat SHARMA, Pasadena, CA (US); Marc P. SAVANIER, Del Mar, CA (US); Elena REZAEIFAR BAYAT, San Clemente, CA (US); Thierry J. PINGUET, Arlington, WA (US)

(21) Appl. No.: 19/037,813

(22) Filed: Jan. 27, 2025

(51) Int. Cl. G02F 1/21; G02F 1/025; G02F 1/225

(52) U.S. Cl. CPC G02F 1/217; G02F 1/025; G02F 1/225; G02F 2201/08; G02F 2201/30; G02F 2203/03; G02F 2203/21; G02F 2203/48

(57) ABSTRACT

Embodiments herein describe an interferometric waveguide in a variable optical attenuator (VOA) that includes a phase tuner that introduces a local phase that redirects an optical signal transmitted in the waveguide to an optical absorber or scatterer, thereby attenuating the signal. That is, by controlling the local phase change, the VOA can selectively attenuate an optical signal using the optical absorber or scatterer (or both).

### TECHNICAL FIELD

Embodiments presented in this disclosure generally relate to using local phase adjustments to direct optical signals to an optical absorber or scatterer in a variable optical attenuator (VOA).

### BACKGROUND

A variable optical attenuator (VOA) is a device that controls the amount of optical power in an optical signal, and is often used in telecommunication networks. VOAs are used for a variety of purposes including adjusting signal levels in optical fiber communication systems, testing the bit error rate of a telecom system, equalizing light power among different channels in fiber amplifier, and controlling laser power in application where direct adjustment of the laser output is not practical. VOAs can be used at both transmit and receive ends of a communication link. Preferably, the VOA should be stable, have a low insertion loss at no bias, and exhibit sufficient dynamic range upon biasing (i.e., the device should not require calibration or active tuning).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate different states of a variable optical attenuator (VOA) with optical absorbers, according to embodiments herein.

FIGS. 2A and 2B illustrate different states of a VOA with optical scatterers, according to embodiments herein.

FIGS. 3A and 3B illustrate field profiles for two states of a VOA with optical absorbers, according to embodiments herein.

FIG. 4A illustrates a VOA with a phase tuner to generate a local phase change, according to embodiments herein.

FIG. 4B is a cross section of FIG. 4A, according to one embodiment herein.

FIG. 5 illustrates a relationship between power, wavelength, and temperature for the VOAs described according to embodiments herein.

FIG. 6 illustrates performance metrics for different length VOAs, according to one embodiment herein.

FIG. 7 illustrates performance metrics associated with local phase tuning, according to one embodiment herein.

FIG. 8 is a flowchart for operating a VOA, according to one embodiment herein.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a variable optical attenuator (VOA) that includes an interferometric waveguide, a phase tuner configured to generate a local phase change in the interferometric waveguide, and an optical absorber or optical scatterer formed on or in the interferometric waveguide, where the local phase change modifies an optical field interference pattern of multi-modes in an optical signal propagating in the interferometric waveguide to change an overlap of optical fields of the multi-modes with the optical absorber or optical scatterer.

One embodiment presented in this disclosure is a VOA that includes a waveguide, a phase tuner configured to generate an asymmetric phase change in the waveguide, and an optical absorber or optical scatterer formed on or in the waveguide, where the asymmetric phase change changes a field profile of an optical signal propagating in the waveguide so that more, or less, optical power overlaps with the optical absorber or optical scatterer.

One embodiment presented in this disclosure is a method that includes adjusting, in an attenuation state of a VOA, a local phase change in an interferometric waveguide to move nulls of a field profile away from an optical absorber or scatterer; and adjusting, in a full-power state of the VOA, a local phase change in the interferometric waveguide to move nulls of the field profile towards the optical absorber or scatterer.

### EXAMPLE EMBODIMENTS

Embodiments herein describe an interferometric waveguide in a variable optical attenuator (VOA) that includes a phase tuner that introduces a local phase that modifies an optical field interference pattern of multi-modes in an optical signal transmitted in the waveguide so that optical fields of the multi-modes overlap more with an optical absorber or scatterer, thereby attenuating the signal. That is, by controlling the local phase change, the VOA can selectively attenuate an optical signal using the optical absorber or scatterer (or both).

In a full-power (or ON state), the local phase is set so that a field profile of the optical signal has nulls at the optical absorber or scatterer. As such, very little of the optical signal is dissipated by the optical absorber or scatterer. In contrast, in an attenuation state, the local phase is set to move the field profile so that the nulls are moved away from the optical absorber or scatterer. As a result, the optical signal is absorbed or dissipated by the optical absorber or scatterer.

In one embodiment, the local phase change is asymmetrically applied, and thus, can be referred to as an asymmetric, local phase change. For example, the phase change may be applied more on one side of the waveguide than the other side in order to adjust the nulls in the field profile. If the phase change was applied symmetrically (e.g., equally on both sides, or applied over the entire waveguide), the field profiles would shift in a manner that would require a very large phase change to move the nulls away from (or towards) the optical absorbers or scatterers in the waveguide. In contrast, asymmetric, local phase changes can provide the desired change in the field profile with much less power.

The optical absorber can be a variety of structures, such as a germanium block, one or more metal contacts, or any other structure or material that absorbs the wavelength of the optical signal. The optical scatterer can be etched into the walls or sides of the waveguide. For example, the optical scatterer could be a grating that has a triangle, square, or saw tooth pattern. The optical scatterer can be any periodic or non-periodic perturbation in material index. The optical scatterer can be a metal layer or other material (e.g., poly-silicon) that is locally deposited on the side, top, or bottom at specific locations on the waveguide. In other examples, the optical scatterer includes etched holes.

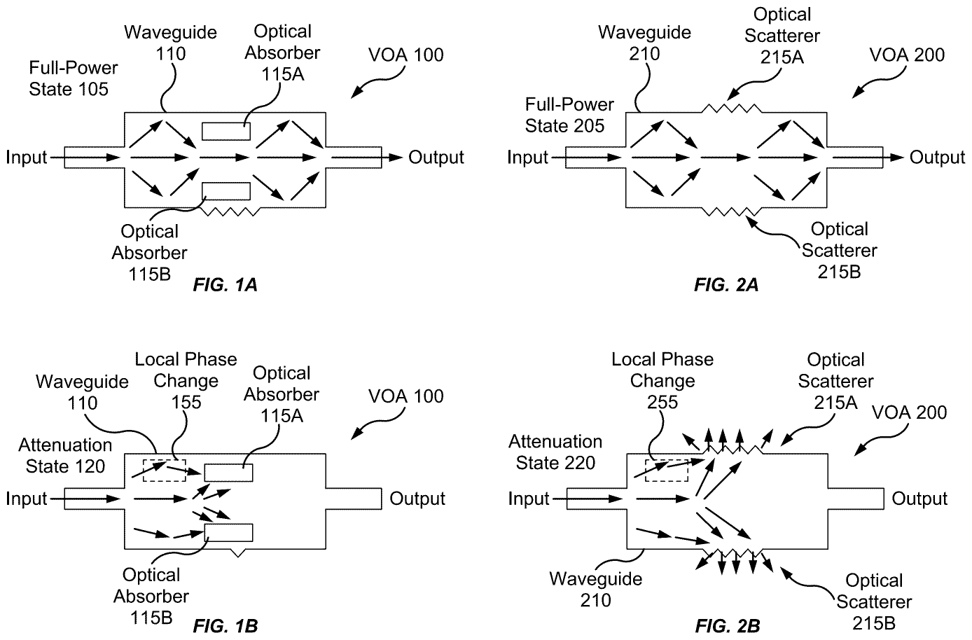

FIGS. 1A and 1B illustrate different states of a VOA 100 with optical absorbers 115, according to embodiments herein. The VOA 100 includes a waveguide 110 (e.g., an interferometric waveguide) that receives an optical signal at an input. In this example, the width of the waveguide 110 increases from the output to the middle portion, before again shrinking at the output of the waveguide (which can couple to downstream optical components).

An interferometric waveguide (or an interferometric waveguide section) is a structure (or a subcomponent in another structure) where the width or geometry of the waveguide induces multi-modes which then interfere with each other causing the field patterns discussed herein. The geometry and shape of the interferometric waveguide does not have to be rectangular and the shape is, in fact, another parameter that can be used to shape the field profiles. The interferometric waveguide can be formed from silicon, silicon nitride, or other suitable material.

As discussed below, a local phase change can be used to modify an optical field interference pattern of the multi-modes in the optical signal propagating in the interferometric waveguide to change an overlap of the optical fields of the multi-modes with an optical absorber 115 (or an optical scatterer as discussed in FIGS. 2A and 2B). The size of the middle portion of the waveguide 110 (also referred to as the box) can vary depending on the wavelength of the optical signal. For optical signals around 1300-1400 nm, the box may have a width (in the vertical direction in FIG. 1A) between 3-8 microns and a length (in the horizontal direction in FIG. 1A) of 80-110 microns. In one embodiment, the box has a width less than 10 microns and a length less than 110 microns. For example, for optical signals around 1310 nm, the box may have a width of approximately 5 microns and a length of approximately 95-100 microns.

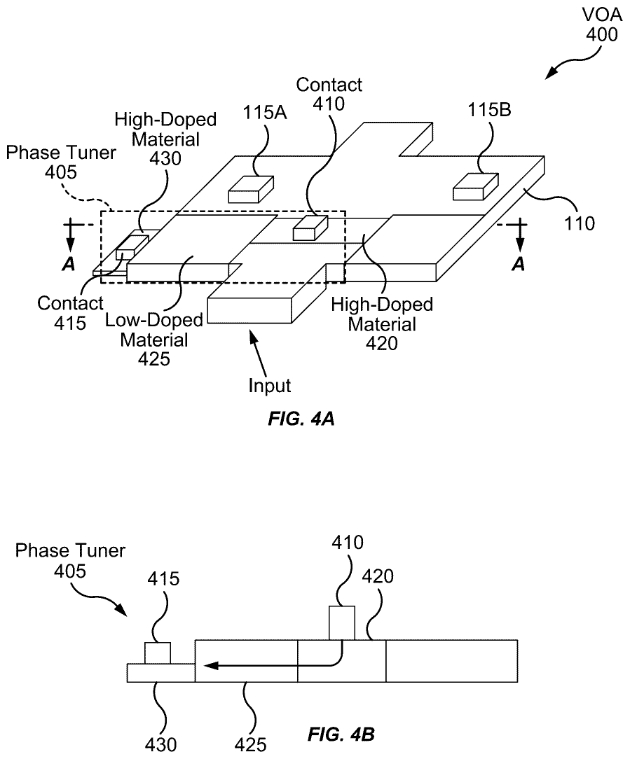

The middle/box portion of the waveguide 110 includes optical absorbers 115A and 115B. The optical absorbers 115 can be a variety of structures such as a germanium blocks disposed on top or bottom of the waveguide, a metal contact disposed on top or bottom of the waveguide, a transparent conductive oxide (TCO) (e.g., indium tin oxide (ITO)) or any other structure or material that absorbs light at the wavelength of the optical signal. In one embodiment, the optical absorbers 115 are disposed at a bottom or top surface of the waveguide 110 (which is shown in FIG. 4B). In other embodiments, the optical absorbers 115 may be slightly recessed into the waveguide—e.g., may extend into the waveguide (in the direction into/out of the page of FIG. 1A), but may not extend all the way through the waveguide.

Like the overall dimensions of the box in the waveguide 110, the dimensions of the optical absorbers 115 can vary depending on the wavelength of the optical signal. For 1310 nm, the optical absorbers can be approximately 1 micron wide and have a length of 5 microns.

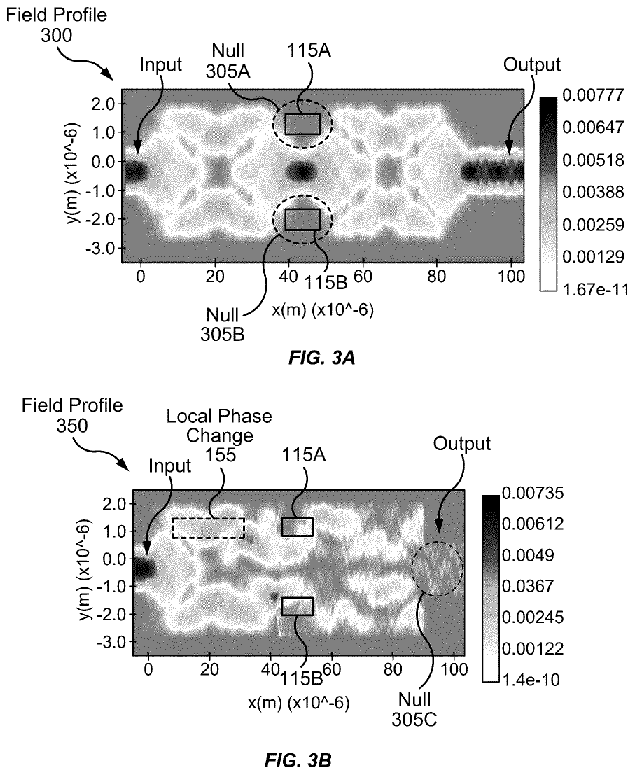

The locations of the optical absorbers 115 in the box depends on the field profile of the optical signal. FIG. 1A illustrates a full-power state 105 (or ON state) of the VOA 100. In this state, the optical signal at the input travels through the waveguide 110 and reaches the output without much (or any) attenuation loss because of the optical absorbers 115. To do this, the VOA 100 can be designed so that the optical absorbers 115 are disposed at nulls in the field profile for the optical signal. Because the optical signal is weak at the nulls, very little of the optical signal is absorbed by the optical absorbers 115, and thus, the optical signal reaches the output with approximately the same amount of optical power it had when entering the input of the waveguide 110. Examples of the field profiles are discussed in FIGS. 3A and 3B below.

The arrows in the waveguide 110 represent the extent of the field distribution within the waveguide 110 in the full-power state 105. As shown, the optical signal travels substantially parallel with the waveguide 110 at the input. However, when the width of the waveguide 110 flares, the optical signal flares out, where some power of the optical signal is directed to the sidewalls of the waveguide 110. The optical signal then reflects off the sidewalls and recombines at the middle of the waveguide, thereby avoiding the optical absorbers 115. The optical signal can then flare out again, is reflected by the sidewalls, and recombines at the output. In this manner, the optical signal can traverse the waveguide 110 without much, if any, appreciable attenuation.

FIG. 1B illustrates the VOA 100 which has the same structure as in FIG. 1A. However, in FIG. 1B, a phase tuner (not shown) creates a local phase change 155 in the waveguide 110. Different examples of suitable phase tuners will be discussed below in FIG. 4A.

In one embodiment, the phase tuner creates the local phase change 155 by changing the refraction index of the waveguide 110 at the location of the phase change 155. Changing the refraction index translates into a phase change of the optical signal at that location. The phase change in turn changes the field profile, and more specifically, changes the locations of the nulls in the field profile. In one embodiment, the location of the phase tuner is selected so the local phase change 155 moves the nulls of the field profile away from the optical absorbers 115. Stated differently, the local phase change 155 directs more light of the optical signal towards the optical absorbers 115, which then attenuates the optical signal (i.e., less optical signal propagates to the output of the VOA 100. As such, FIG. 1B illustrates an attenuation state 120 of the VOA 100 where at least some of the light of the optical signal is intentionally absorbed by the optical absorbers 115 using the local phase change 155.

In one embodiment, substantially all of the light is absorbed by the optical absorbers 115, in which case, very little or no optical signal is at the output. This can be referred to as the OFF state. Like in FIG. 1A, the arrows in FIG. 1B the extent of the field distribution in the waveguide 110. Here, the local phase change 155 changes the field profile so that most of the optical signal is directed towards the optical absorbers 115 where the light is absorbed. Thus, there would be no light at the output of the VOA 100.

However, the local phase change 155 can be set to partially attenuate the optical signal in the attenuation state 120 (e.g., provide a 25%, 50%, or 75% attenuation of the optical signal at the output). As such, the VOA 100 can be controlled by changing the local phase change 155 to provide any desired attenuation (or no attenuation).

Notably, in this embodiment the local phase change 155 is not applied equally to both sides of the waveguide 110. For example, the waveguide 110 can be divided up by an axis extending through the middle of the waveguide 110 in the direction of propagation to form an upper half of the waveguide 110 and a lower half of the waveguide 110. In this example, the local phase change 155 is applied in the upper half of the waveguide 110, where no phase change is applied in the lower half of the waveguide 110. As such, the local phase change 155 is an asymmetric phase change since one half of the waveguide is affected more than the other half. That is, the phase tuner can create the asymmetric local phase change in a region of the waveguide 110 that is closer to one side of the waveguide 110 than an opposite side of the waveguide 110.

While FIG. 1B illustrates applying the local phase change 155 in the upper half, some of the phase change could be applied in the lower half of the waveguide 110, so long as more phase change is applied in one side than the other. Moreover, in another embodiment, the local phase change may be applied in the lower half rather than in the upper half of the waveguide 110.

In one embodiment, the local phase change 155 and the optical absorbers 115 form a multi-mode interferometer (MMI). The discussion above illustrates how the interference field profile in the MMI can be altered to adjust the power at the MMI output. The placement of the absorbers 115 can then be done to optimally disrupt the optical field interference pattern to increase the efficiency of the device.

In addition, while FIGS. 1A and 1B illustrate applying the local phase change in the attenuation state 120 and not applying a phase change in the full-power state 105, the reverse could be true. That is, the VOA 100 could apply the local phase change 155 to move the nulls of the field profile at the optical absorbers 115 so the VOA 100 is in the full-power state 105, but then when no phase change is applied, the field profile may shift such that the nulls are no longer at the optical absorbers and the light is absorbed by the optical absorbers 115 in the attenuation state 120.

FIGS. 2A and 2B illustrate different states of a VOA 200 with optical scatterers, according to embodiments herein. The VOA 200 includes a waveguide 210 (e.g., an interferometric waveguide) that receives an optical signal at an input. In this example, the width of the waveguide 210 increases from the output to the middle portion, before again shrinking at the output of the waveguide (which can couple to downstream optical components). The size of the middle portion or box of the waveguide 210 can vary like the waveguide 110 discussed in FIGS. 1A and 1B—e.g., for optical signals around 1300-1400 nm, the box may have a width (in the vertical direction) between 3-8 microns and a length (in the horizontal direction) of 80-110 microns.

The middle/box portion of the waveguide 210 includes optical scatterers 215A and 215B. The optical scatterers 215 can be a variety of structures etched or formed in the sidewalls of the waveguide 210. In one embodiment, the scatterers 215 are gratings which can have a variety of different shapes such as triangle, square, or saw tooth patterns.

Like the overall dimensions of the box in the waveguide 110, the dimensions of the optical scatterers 215 can vary depending on the wavelength of the optical signal. For example, the length of the optical scatterers 215 can range between 2-10 microns.

The locations of the optical scatterers 215 in the box depends on the field profile of the optical signal. FIG. 2A illustrates a full-power state 205 (or ON state) of the VOA 200. In this state, the optical signal at the input travels through the waveguide 210 and reaches the output without much (or any) attenuation loss because of the optical scatterers 215. To do this, the VOA 200 can be designed so that the optical scatterers 215 are disposed at nulls in the field profile for the optical signal. Because the optical signal is weak at the nulls, very little of the optical signal is scattered (or dissipated) by the optical scatterers 215, and thus, the optical signal reaches the output with approximately the same amount of optical power it had when entering the input of the waveguide 210.

The arrows in the waveguide 210 represent the extent of the field distribution within the waveguide 210 in the full-power state 205. As shown, the optical signal travels substantially parallel with the waveguide 210 at the input. However, when the width of the waveguide 210 flares, the optical signal flares out, where some power of the optical signal is directed to the sidewalls of the waveguide 210. Notably, these portions of the sidewalls do not have the optical scatterers 215. The optical signal then reflects off the sidewalls and recombines at the middle of the waveguide, thereby avoiding the portion of the sidewalls that do contain the optical scatterers 215. The optical signal can then flare out again, is reflected by another portion of the sidewalls that do not have the scatterers 215, and recombines at the output. In this manner, the optical signal can traverse the waveguide 210 without much, if any, appreciable attenuation.

FIG. 2B illustrates the VOA 200 which has the same structure as in FIG. 2A. However, in FIG. 2B, a phase tuner (not shown) creates a local phase change 255 in the waveguide 210. Different examples of suitable phase tuners will be discussed below in FIG. 4A.

The local phase change 255 can be applied in the same way as discussed in FIGS. 1A and 1B where the phase tuner creates the local phase change 255 by changing the refraction index of the waveguide 210 at the location of the phase change 255. Changing the refraction index translates into a phase change of the optical signal which in turn changes the field profile, and more specifically, changes the locations of the nulls in the field profile. In one embodiment, the location of the phase tuner is selected so the local phase change 255 moves the nulls of the field profile away from the optical scatterers 215. Stated differently, the local phase change 255 directs more power of the optical signal towards the optical scatterers 215, which then attenuates the optical signal (i.e., less optical signal propagates to the output of the VOA 200. As such, FIG. 2B illustrates an attenuation state 220 of the VOA 200 where at least some of the light of the optical signal is intentionally scattered out of the waveguide 210 by the optical scatterers 215 using the local phase change 255.

In one embodiment, substantially all of the light is scattered by the optical scatterers 215, which can be referred to as the OFF state of the VOA 200. Like in FIG. 2A, the arrows in FIG. 2B represent the extent of the field distribution in the waveguide. Here, the local phase change 255 changes the field profile so that most of the optical signal is directed towards the optical scatterers 215 where the light is scattered out of the waveguide 210. Thus, there would be no light at the output of the VOA 200.

However, the local phase change 255 can be set to partially attenuate the optical signal in the attenuation state 220 (e.g., provide a 25%, 50%, or 75% attenuation of the optical signal at the output).

Like the phase change 155 in FIGS. 1A and 1B, the local phase change 255 is not applied equally to both sides of the waveguide 110. As discussed above, this asymmetric phase change can move the nulls of the field profile more effectively than a symmetric phase change where a phase change is applied across the entire waveguide 210.

While FIG. 2B illustrates applying the local phase change 255 in the upper half, some of the phase change could be applied in the lower half of the waveguide 210, so long as more phase change is applied on one side than the other. Moreover, in another embodiment, the local phase change may be applied in the lower half rather than in the upper half of the waveguide 210.

In one embodiment, the local phase change 255 and the optical scatterers 215 form a MMI. The discussion above illustrates how the interference field profile in the MMI can be altered to adjust the power at the MMI output. The placement of the scatterers 215 can then be done to optimally disrupt the optical field interference pattern to increase the efficiency of the device.

In addition, while FIGS. 2A and 2B illustrate applying the local phase change in the attenuation state 220 and not applying a phase change in the full-power state 205, the reverse could be true. That is, the VOA 200 could apply the local phase change 255 to move the nulls of the field profile at the optical scatterers 215 so the VOA 200 is in the full-power state 205, but then when no phase change is applied, the field profile may shift such that the nulls are no longer at the optical absorbers and the light is absorbed by the optical scatterers 215 in the attenuation state 220.

Further, in one embodiment, a VOA could include both the optical absorbers 115 and the optical scatterers 215. For example, this may improve efficiency, or increase the range of wavelengths the VOA can be used with. For example, for some wavelengths, germanium optical absorbers may work better, but with other wavelengths, the optical scatterers may work better. A VOA with both types may be useful in more applications than a VOA that has only one type. The VOA could function the same where a local phase change is used to move the nulls of the field profile towards, or away from, the optical absorbers and scatterers in the full-power and attenuation states.

FIGS. 3A and 3B illustrate field profiles for two states of a VOA with optical absorbers, according to embodiments herein. The field profiles are generated from simulations using the VOA 100 in FIGS. 1A and 1B, which includes the optical absorbers 115.

FIG. 3A illustrates a field profile 300 of the VOA when in the full-power state 105. In one embodiment, the field profile 300 is time averaged. The gradient of the field profile 300 indicates portions of interference (e.g., changes in the optical field interference pattern), which can be constructive or destructive. Specifically, the field profile 300 has multiple nulls, two of which are labeled as null 305A and null 305B. Both of the nulls 305 indicate where the optical signal is weak because of destructive interference. That is, there is little overlap between the optical fields of the multi-modes of the optical signal and the optical absorbers 115A and 115B in the nulls 305A and 305B.

In one embodiment, a designer can perform the simulation shown in FIG. 3A to identify the nulls 305A and 305B, and then place the optical absorbers 115A and 115B at those nulls 305A and 305B. In this manner, when in the full-power state, the optical absorbers 115 have little to no effect on the optical signal. That is, the field passes through the MMI without any issue when no local phase shift is applied—going around the optical absorbers 115 included in the simulation. This is shown in the field profile 300 by the output having a very large signal strength.

In one embodiment, the length of the waveguide is chosen to tap out the power (into the fundamental mode TE0, which is the same mode as the input) at the output. In the full-power state, light passes through without incurring any additional loss. The VOA may be a MMI such that within the waveguide the optical signal is multi-modal, but then at the inputs and outputs is a single mode (e.g., TE0).

FIG. 3B illustrates a field profile 350 of the same VOA when in the attenuation state 120 corresponding to FIG. 1B. Here, the phase tuner has applied the local phase change 155 which changes the field profile. As shown, there are no longer nulls at the optical absorbers 115A and 115B. Instead, the field profile indicates that local phase change 155 directs the optical signal to the optical absorbers 115 where the light is absorbed. As such, there is a null 305C at the output, indicating little to no light exits the VOA/MMI.

Also, there are other nulls in the field profiles 300 and 350 other than the ones that were labeled. These nulls can advantageously be used to dispose other components in the VOA. For example, electrical contacts for the phase tuner may be disposed in nulls (e.g., a null that is in both field profiles 300 and 350) so a metal contact does not have a negative impact on the optical light in either the full-power or attenuation states (e.g., create additional loss, especially in the full-power state where is may be desirable for the VOA to be as lossless as possible).

FIG. 4A illustrates a VOA 400 with a doped phase tuner 405 to generate a local phase change, according to embodiments herein. This plan view illustrates the optical absorbers 115 disposed on top of the waveguide 110. The waveguide 110 may be formed from silicon or a material containing silicon. However, the embodiments herein are not limited to silicon waveguides and can apply to other types of waveguides.

In this example, the doped phase tuner 405 is implemented using a metal contact 410 (e.g., TCO) disposed on a high-doped material 420 (e.g., heavily doped silicon that is also part of the waveguide 110), a low-doped material 425 (e.g., low doped silicon, e.g., intrinsic silicon, that is also part of the waveguide 110), a high-doped material 430 (e.g., heavily doped silicon), and another metal contact 415.

FIG. 4B is a cross section of A-A in FIG. 4A of the doped phase tuner 405. In one embodiment, the heavily doped material 425 is doped one type (e.g., N type) while the heavily doped material 430 is doped the other type (e.g., P type). The low-doped material 425 can be an intrinsic (low doped or no doping). In this example, the phase tuner 405 is a P-i-N diode.

As current flows through the phase tuner 405 as shown in FIG. 4B, charge carriers (e.g., holes or electrons) are either removed or added, which impacts the index of refraction at the phase tuner 405. This change in the refraction index causes the local phase changes discussed above which in turn change the field profile to cause the optical signal to overlap more, or less with, the optical absorbers 115.

However, the phase tuner 405 is an example of just one suitable phase tuner 405. Other types of phase tuners that can be added to the VOA to cause a local phase change include a doped silicon resistor (e.g., a heater) embedded to the side or on the top/bottom of the waveguide 110, a Schottky diode which can include a direct metal or silicon junction, a TiN heater, or phase change materials (PCMs).

Moreover, while the optical absorbers 115 are shown as being on the top of the waveguide 110, they could also be disposed on the sides of the waveguide 110. Further, although shown as being rectangular, in other embodiments the absorbers 115 may be circular, elliptical, or have any other shape which may better match the nulls in the field profile.

Moreover, while the optical scatterers illustrated in FIGS. 2A and 2B were shown on the sidewalls of the waveguide, they could also be disposed on the top (or bottom) of the waveguide 210 like the optical absorbers 115 in FIG. 4A.

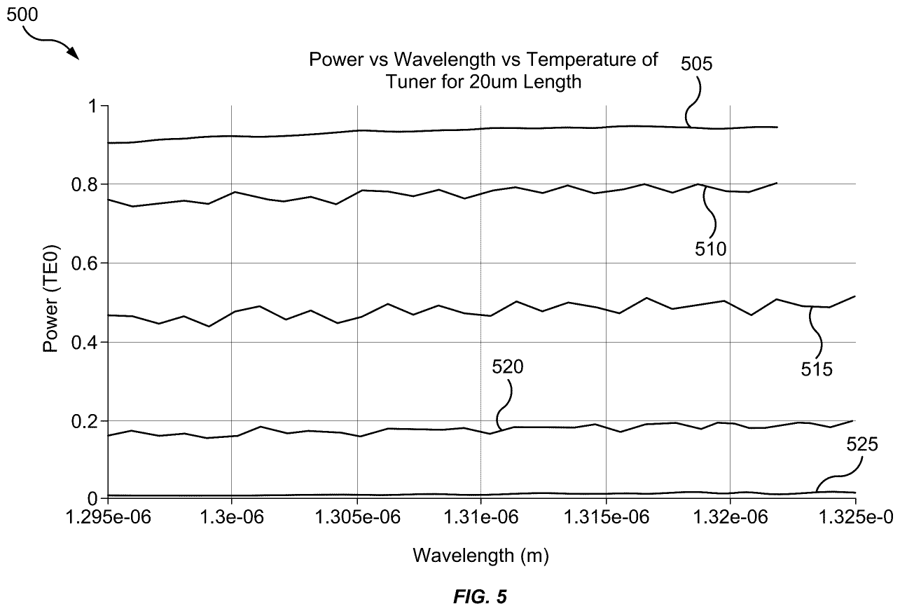

FIG. 5 illustrates a relationship between power, wavelength, and temperature for the VOAs described according to embodiments herein. In chart 500, the plot 505 corresponds to a temperature of 300 degrees K, the plot 510 corresponds to a temperature of 350 degrees k, the plot 515 corresponds to a temperature of 400 degrees K, the plot 520 corresponds to a temperature of 450 degrees K, and the plot 525 corresponds to a temperature of 500 degrees K. The Y axis is the power in the TE0 mode of the optical signal while the X axis is the wavelength of the optical signal. Moreover, the chart 500 is based on using optical absorbers but similar results are expected for optical scatterers.

Chart 500 illustrates that the advantages of the VOAs described herein are not narrowband and can cover a large wavelength range without the need to redesign the VOA.

Moreover, there may be a tradeoff between the length of the tuned segment and the change in phase needed to achieve extinction.

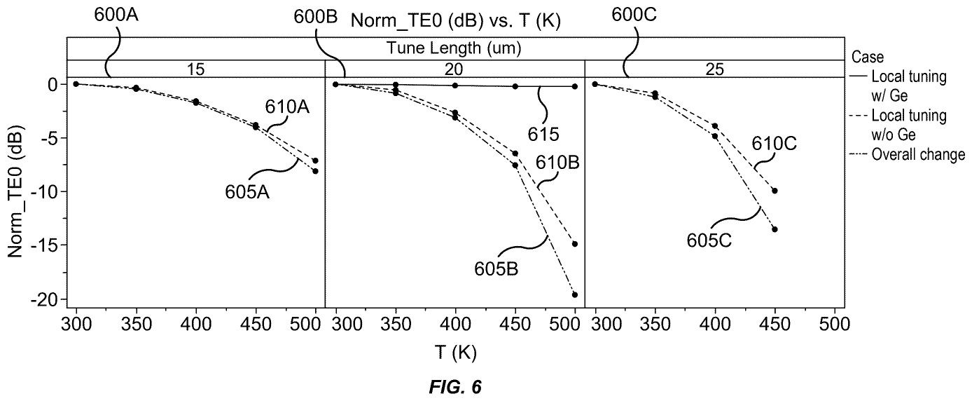

FIG. 6 illustrates performance metrics for different length VOAs, according to one embodiment herein. FIG. 6 illustrates charts 600A-C where the plots 605A-C illustrate performing local tuning (e.g., using the local phase changes discussed above) with optical absorbers/scatterers and the plots 610A-C illustrate performing local turning without the optical absorbers/scatterers. The plot 615 illustrates performing global tuning where a thermal phase tuner changes the entire refraction index and phase of the MMI as a whole (e.g., the entire MMI is covered with a thermal phase tuner).

The chart 600A represents a MMI with a tune length of 15 microns, the chart 600B represents a MMI with a tune length of 20 microns, and the chart 600C represents a MMI with a tune length of 25 microns. The Y axis of the charts 600A-C illustrate their attenuation while the X axis illustrates the temperature applied by the thermal phase tuner. As the temperature rises, more phase change is applied.

The plots 610A-C indicate that phase change, even without the optical absorbers/scatterers can attenuate the optical signal. However, the plots 605A-C indicate the much more attenuation is achieved when the optical absorbers/scatterers are used. Further, the plot 615 indicates that applying a global phase change does not attenuate the signal, thereby indicating the advantage of using a local, asymmetric phase change.

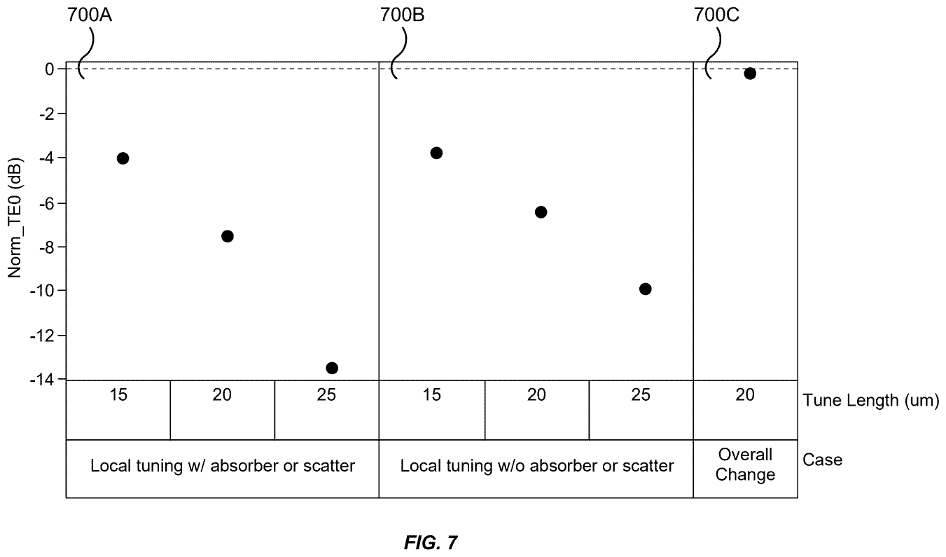

FIG. 7 illustrates performance metrics associated with local phase tuning, according to one embodiment herein. Chart 700A illustrates the effects of local tuning with the absorber or scatterer with tuning length segments of 15 microns, 20 microns, and 25 microns. The Y axis indicates the attenuation achieved at those lengths of a temperature of 150 degrees K.

Chart 700B illustrates the effects of local tuning without the absorber or scatterer with tuning length segments of 15 microns, 20 microns, and 25 microns. The Y axis indicates the attenuation achieved at those lengths at a temperature of 150 degrees K.

Chart 700C illustrates the effects of global tuning where the entire MMI is heated to 150K. Only the tuning segment of 20 microns is shown in this chart.

By comparing the charts 700A-C, it is shown that local tuning enables some attenuation of the optical signal, while changing the temperature/phase along the entire length of the MMI does not. However, adding the optical absorbers or scatterers can offer even greater attenuation, especially for longer tune lengths.

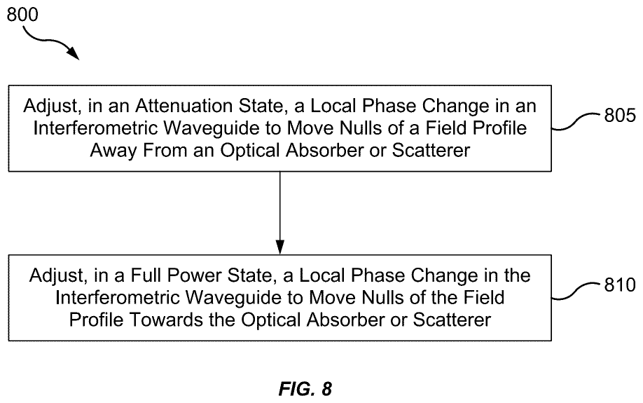

FIG. 8 is a flowchart of a method 800 for operating a VOA, according to one embodiment herein. At block 805, the VOA adjusts, in an attenuation state, a local phase change in an interferometric waveguide to move nulls of a field profile away from an optical absorber or scatterer. In one embodiment, adjusting the local phase change is performed using a phase tuner, such as the P-i-N diode shown in FIGS. 4A and 4B, a Schottky diode, thermal phase tuners, PCMs, and the like.

In one embodiment, the local phase change means the phase change is not applied along the entire length of a MMI in the VOA, such as the local phase changes shown in FIGS. 1B and 2B. Moreover, in one embodiment, the local phase change is asymmetric so that the local phase change is applied more in one half of the MMI than the other half. Put differently, the phase change is not centered along a center line of the MMI.

Moreover, adjusting the local phase may be performed by increasing the local phase change or by decreasing the local phase change. For example, in one embodiment, the VOA may be in the attenuation state when the phase tuner does not apply any phase change to the MMI. In another embodiment, the VOA may enter into the attenuation state when the phase tuner begins to apply the local phase change. In that case, the VOA is in the full-power state when the phase tuner does not apply any local phase change to the MMI.

At block 810, the VOA adjusts, in a full-power state, a local phase change in the interferometric waveguide to move a null of a field profile towards the optical absorber or scatterer. Put differently, the VOA controls the phase tuner opposite in the manner it was controlled at block 805. For example, if at block 805 the phase tuner injected charge carriers into the waveguide of the MMI, then at block 810, the phase tuner reduces or stops injecting charge carriers into the waveguide. If at block 805 the phase tuner heated up the waveguide of the MMI, then at block 810, the phase tuner stops applying heat to the waveguide, which lets the waveguide cool. In this manner, a local phase change can be used to control the attenuation of a VOA using optical absorbers and/or scatterers.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. A variable optical attenuator (VOA) comprising:
an interferometric waveguide;
a phase tuner configured to generate a local phase change in the interferometric waveguide; and
an optical absorber or optical scatterer formed on or in the interferometric waveguide, wherein the local phase change modifies an optical field interference pattern of multi-modes in an optical signal propagating in the interferometric waveguide to change an overlap of optical fields of the multi-modes with the optical absorber or optical scatterer.

2. The VOA of claim 1, wherein, when in a full-power state, the phase tuner is controlled so that the optical absorber or optical scatterer is in a null of a field profile of the interferometric waveguide.

3. The VOA of claim 2, wherein, when in an attenuation state, the phase tuner sets the local phase change so that the overlap of the optical fields of the multi-modes with the optical absorber or optical scatterer is increased.

4. The VOA of claim 3, wherein, when in the attenuation state, the phase tuner sets the local phase change to move the null away from the optical absorber or optical scatterer.

5. The VOA of claim 1, wherein the VOA comprises the optical absorber which includes germanium, wherein the optical absorber contacts a surface of the interferometric waveguide.

6. The VOA of claim 5, wherein the optical absorber is recessed into the interferometric waveguide.

7. The VOA of claim 1, wherein the VOA comprises the optical scatterer which includes a grating formed on a side of the interferometric waveguide.

8. The VOA of claim 1, wherein the phase tuner is arranged in the VOA to generate an asymmetric local phase change.

9. The VOA of claim 8, wherein the asymmetric local phase change is in a region of the interferometric waveguide that is closer to one side of the interferometric waveguide than an opposite side of the interferometric waveguide.

10. The VOA of claim 1, wherein the interferometric waveguide has a width that is less than 10 microns and a length that is less than 110 microns.

11. The VOA of claim 1, wherein the phase tuner comprises at least one of: a P-i-N diode formed at least partially in the interferometric waveguide, a doped thermal tuner formed within the interferometric waveguide, a Schottky diode formed on the interferometric waveguide, a TiN heater, or a phase change material.

12. The VOA of claim 1, wherein the VOA comprises the optical absorber which comprises metal contacts formed on the interferometric waveguide.

13. A variable optical attenuator (VOA) comprising:
a waveguide;
a phase tuner configured to generate an asymmetric phase change in the waveguide; and
an optical absorber or optical scatterer formed on or in the waveguide, wherein the asymmetric phase change changes a field profile of an optical signal propagating in the waveguide so that more, or less, optical power overlaps with the optical absorber or optical scatterer.

14. The VOA of claim 13, wherein, when in a full-power state, the phase tuner is controlled so that the optical absorber or optical scatterer is in a null of the field profile of the waveguide.

15. The VOA of claim 14, wherein, when in an attenuation state, the phase tuner sets the asymmetric phase change so that there is more overlap between an optical field of the optical signal and the optical absorber or optical scatterer.

16. The VOA of claim 15, wherein, when in the attenuation state, the phase tuner sets the asymmetric phase change to move the null away from the optical absorber or optical scatterer.

17. The VOA of claim 13, wherein the VOA comprises the optical absorber which includes germanium, wherein the optical absorber contacts a surface of the waveguide.

18. The VOA of claim 13, wherein the VOA comprises the optical scatterer which includes a grating formed on a side of the waveguide.

19. The VOA of claim 13, wherein the asymmetric phase change is in a region of the waveguide that is closer to one side of the waveguide than an opposite side of the waveguide.

20. A method comprising:
adjusting, in an attenuation state of a variable optical attenuator (VOA), a local phase change in an interferometric waveguide to move nulls of a field profile away from an optical absorber or scatterer; and
adjusting, in a full-power state of the VOA, a local phase change in the interferometric waveguide to move nulls of the field profile towards the optical absorber or scatterer.
